(19) United States
(12) Patent Application Publication
(10) Pub. No.: US 2024/0031018 A1
(43) Pub. Date: Jan. 25, 2024

(54) MULTIPLEX TRANSMISSION SYSTEM, RESOURCE CONTROL METHOD FOR MULTIPLEX TRANSMISSION SYSTEM

(71) Applicant: NIPPON TELEGRAPH AND TELEPHONE CORPORATION, Tokyo (JP)

(72) Inventors: Hiroko NOMURA, Musashino-shi, Tokyo (JP); Keita TAKAHASHI, Musashino-shi, Tokyo (JP)

(73) Assignee: NIPPON TELEGRAPH AND TELEPHONE CORPORATION, Tokyo (JP)

(21) Appl. No.: 18/028,807

(22) PCT Filed: Oct. 7, 2020
(86) PCT No.: PCT/JP2020/038019

§ 371 Date: Mar. 28, 2023

(51) Int. Cl. H04B 10/032

(52) U.S. Cl. CPC H04B 10/032

(57) ABSTRACT

Provided is a multiplex transmission system capable of realizing a redundant configuration for coping with a failure while reducing useless resources. A multiplex transmission system includes: a resource pool 130 which is provided in a first multiplex transmission apparatus 100 and which has a resource that enables a function to be rewritten; and a management control unit 140 which controls the resource pool 130. The first multiplex transmission apparatus 100 includes: at least one client port to which a client apparatus can be connected; a transmission/reception unit corresponding to the client port; a standby system client port; and a standby system transmission/reception unit corresponding to the standby system client port. During normal time, an electrical processing function associated with each of the transmission/reception units is constructed in the resource pool 130. When a failure occurs in the transmission/reception unit, the management control unit 140 controls the resource pool 130 so as to release a resource in which is constructed an electrical processing function associated with the transmission/reception unit and to construct an electrical processing function associated with the standby system transmission/reception unit in the resource.

### TECHNICAL FIELD

The present disclosure relates to a multiplex transmission system and a resource control method for the multiplex transmission system.

### BACKGROUND ART

A multiplex transmission system for multiplexing and transmitting a plurality of signals between two points is disclosed in NPL 1. Specifically, NPL 1 discloses multiplexing a plurality of signals using wavelength division multiplexing (WDM). At each of the two points to be transmitted, a multiplex transmission apparatus for performing wavelength demultiplexing is installed.

In addition, a redundancy technique of an access network is described in NPL 2. In order to cope with various failures such as a disconnection of an optical fiber cable connecting a multiplex transmission apparatus or a breakdown of a transmission/reception unit (TRx) in the multiplex transmission apparatus, a redundancy technique as described in NPL 2 is required.

### CITATION LIST

### Non Patent Literature

[NPL 1] Optical Interface Standardization Trend of Access Networks, NTT Technical Journal, July 2007, pp. 46-49 [NPL 2] Next-Generation Ethernet Technology for The NGN Era, NTT Technical Journal, May 2009, pp. 22-23

### SUMMARY OF INVENTION

### Technical Problem

In a conventional redundancy technique such as that described in NPL 2, it is necessary to secure a large resource of a standby system in advance from a stage of introduction of a multiplex transmission system in preparation for a failure. This large resource ends up being wasted during normal time where no failure occurs.

The present disclosure has been devised to solve the foregoing problem. An object of the present disclosure is to provide a multiplex transmission system and a multiplex transmission system resource control method capable of realizing a redundant configuration for coping with a failure while reducing useless resources.

### Solution to Problem

A multiplex transmission system according to the present disclosure is a multiplex transmission system which multiplexes and transmits a plurality of signals between a first multiplex transmission apparatus and a second multiplex transmission apparatus, the multiplex transmission system including: a resource pool which is provided in the first multiplex transmission apparatus and which has a resource that enables a function to be rewritten; and a control unit which controls the resource pool. The first multiplex transmission apparatus includes: at least one client port to which a client apparatus can be connected; a transmission/reception unit corresponding to the client port; a standby system client port; and a standby system transmission/reception unit corresponding to the standby system client port. During normal time, an electrical processing function associated with each of the transmission/reception units is constructed in the resource pool. When a failure occurs in the transmission/reception unit, the control unit controls the resource pool so as to release a resource in which is constructed an electrical processing function associated with the transmission/reception unit and to construct an electrical processing function associated with the standby system transmission/reception unit in the resource.

A resource control method for a multiplex transmission system according to the present disclosure is a method for controlling, in a multiplex transmission system which multiplexes and transmits a plurality of signals between a first multiplex transmission apparatus and a second multiplex transmission apparatus, a resource pool which is provided in the first multiplex transmission apparatus and which has a resource that enables a function to be rewritten. The resource control method includes the steps of: constructing, during normal time, an electrical processing function associated with each of transmission/reception units provided in the first multiplex transmission apparatus; releasing, when a failure occurs in a transmission/reception unit, a resource in which is constructed an electrical processing function associated with the transmission/reception unit; and constructing an electrical processing function associated with a standby system transmission/reception unit provided in the first multiplex transmission apparatus in the resource released in the step of releasing a resource.

### Advantageous Effects of Invention

With the multiplex transmission system and the resource control method for the multiplex transmission system according to the present disclosure, a redundant configuration for coping with a failure can be realized while reducing useless resources.

### BRIEF DESCRIPTION OF DRAWINGS

FIG. 1 is a diagram schematically showing an example of an overall configuration of a multiplex transmission system according to a first embodiment.

FIG. 2 is a block diagram showing a configuration of a multiplex transmission apparatus included in the multiplex transmission system according to the first embodiment.

FIG. 3 is a flow chart showing a flow of a resource control method for the multiplex transmission system according to the first embodiment.

FIG. 4 is a block diagram describing an operation example in the event of an occurrence of a failure in a transmission/reception unit of the multiplex transmission system according to the first embodiment.

### DESCRIPTION OF EMBODIMENTS

A mode for carrying out a multiplex transmission system and a resource control method for the multiplex transmission system according to the present disclosure will be described with reference to the accompanying drawings. In each drawing, same reference signs are assigned to identical or corresponding parts and repetition of descriptions will be simplified or omitted as deemed appropriate. It should be noted that the present disclosure is not limited to the following embodiment and any constituent element disclosed in the embodiment can be modified or omitted without departing from the spirit and the scope of the present disclosure.

### First Embodiment

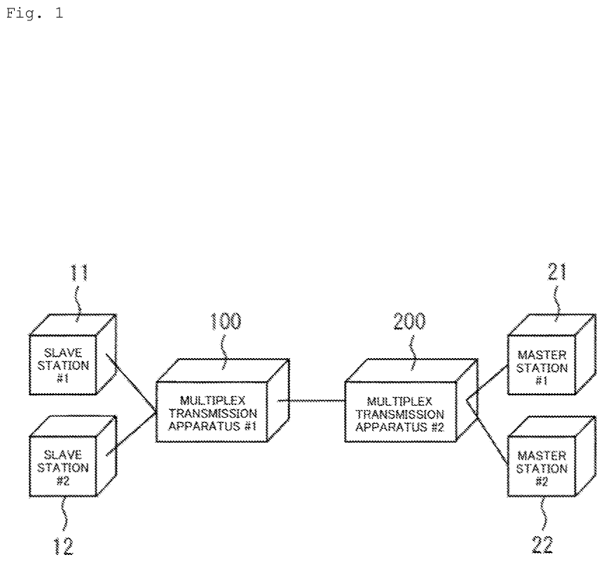

FIG. 1 is a diagram schematically showing an example of an overall configuration of a multiplex transmission system according to a first embodiment. As shown in FIG. 1, the multiplex transmission system according to the present embodiment includes a first multiplex transmission apparatus 100 and a second multiplex transmission apparatus 200. The multiplex transmission system according to the present embodiment is a system for multiplexing and transmitting a plurality of signals between the first multiplex transmission apparatus 100 and the second multiplex transmission apparatus 200. The multiplex transmission system according to the present disclosure is applicable to systems using various known signal multiplexing methods. As a specific signal multiplexing method, wavelength division multiplexing (WDM), frequency division multiplexing (FDM), time division multiplexing (TDM), code division multiplexing (CDM), and the like can be cited. Here, an example in which wavelength division multiplexing (WDM) is used will be described.

The first multiplex transmission apparatus 100 and the second multiplex transmission apparatus 200 are communicably connected by an optical fiber cable. According to the multiplex transmission system, by multiplexing a plurality of signals to be transmitted between two points, the number of optical fiber cables required for transmitting the plurality of signals between the two points can be reduced. For example, the first multiplex transmission apparatus 100 and the second multiplex transmission apparatus 200 can be communicably connected to each other by one optical fiber cable.

One or more slave stations are communicably connected to one of the first multiplex transmission apparatus 100 and the second multiplex transmission apparatus 200. One or more master stations are communicably connected to the other of the first multiplex transmission apparatus 100 and the second multiplex transmission apparatus 200. In the illustrated configuration example, a first slave station 11 and a second slave station 12 are connected to the first multiplex transmission apparatus 100 and a first master station 21 and a second master station 22 are connected to the second multiplex transmission apparatus 200.

In the present embodiment, it is assumed that the multiplex transmission system is applied to a mobile front hole. In this case, the first master station 21 and the second master station 22 correspond to CUs (Central Units) and/or DUs (Distributed Units) of a base station. In addition, in this case, the first slave station 11 and the second slave station 12 correspond to RUs (Radio Units). The first slave station 11 and the first master station 21 are base stations of a first mobile carrier. The second slave station 12 and the second master station 22 are base stations of a second mobile carrier. The first mobile carrier and the second mobile carrier are different mobile carriers (mobile communication providers). An antenna is connected to each slave station. Each antenna outputs a radio wave to an individual area to form a reception area. Each master station may be formed as an individual apparatus for each mobile carrier or formed as an integrated apparatus. Similarly, each slave station may be formed as an individual apparatus for each mobile carrier or formed as an integrated apparatus.

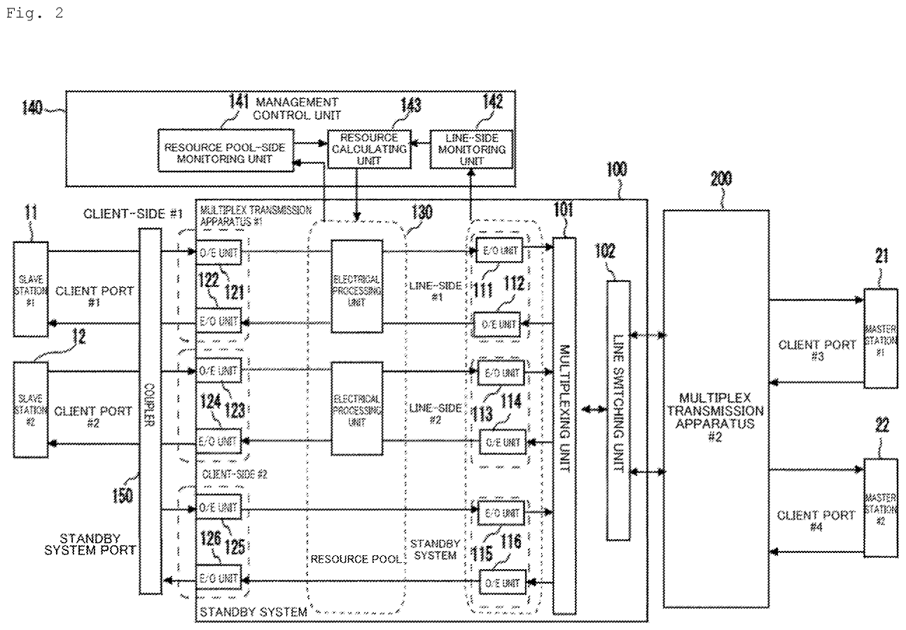

FIG. 2 is a block diagram showing a configuration of a multiplex transmission apparatus included in the multiplex transmission system according to the first embodiment. Here, master stations and slave stations connected to the first multiplex transmission apparatus 100 and the second multiplex transmission apparatus 200 will be collectively called client apparatuses. Each of the first multiplex transmission apparatus 100 and the second multiplex transmission apparatus 200 is provided with a plurality of client ports to which a client apparatus can be connected. In the illustrated configuration example, two client ports are provided in each of the first multiplex transmission apparatus 100 and the second multiplex transmission apparatus 200. In order to facilitate discrimination, the two client ports provided in the first multiplex transmission apparatus 100 will be referred to as a first client port and a second client port. In addition, the two client ports provided in the second multiplex transmission apparatus 200 will be referred to as a third client port and a fourth client port. In each diagram, “first” is indicated by “#1”, “second” is indicated by “#2”, “third” is indicated by “#3”, and “fourth” is indicated by “#4”.

The first client port of the first multiplex transmission apparatus 100 is provided with a first client-side O/E unit 121 and a first client-side E/O unit 122. The second client port of the first multiplex transmission apparatus 100 is provided with a second client-side O/E unit 123 and a second client-side E/O unit 124. The first multiplex transmission apparatus 100 further includes a first line-side E/O unit 111, a first line-side O/E unit 112, a second line-side E/O unit 113 and a second line-side O/E unit 114, and a first multiplexing unit 101.

An optical signal input to the first client port of the first multiplex transmission apparatus 100 is converted into an electric signal by the first client-side O/E unit 121 and output to the first line-side E/O unit 111. The first line-side E/O unit 111 converts the input electric signal into an optical signal and outputs the optical signal to the first multiplexing unit 101. In addition, an optical signal input to the second client port of the first multiplex transmission apparatus 100 is converted into an electric signal by the second client-side O/E unit 123 and output to the second line-side E/O unit 113. The second line-side E/O unit 113 converts the input electric signal into an optical signal and outputs the optical signal to the first multiplexing unit 101.

The first multiplexing unit 101 multiplexes the optical signals input from the first line-side E/O unit 111 and the second line-side E/O unit 113. The optical signal multiplexed by the first multiplexing unit 101 is transmitted from the first multiplex transmission apparatus 100 to the second multiplex transmission apparatus 200.

In addition, a multiplexed optical signal transmitted from the second multiplex transmission apparatus 200 to the first multiplex transmission apparatus 100 is input to the first multiplexing unit 101. The first multiplexing unit 101 separates the multiplexed signal input from the second multiplex transmission apparatus 200 and outputs the separated signal to the first line-side O/E unit 112 and the second line-side O/E unit 114, respectively.

The first line-side O/E unit 112 converts the optical signal input from the first multiplexing unit 101 into an electric signal and outputs the electric signal to the first client-side E/O unit 122. The first client-side E/O unit 122 converts the input electric signal into an optical signal and outputs the optical signal to the first client port of the first multiplex transmission apparatus 100. The second line-side O/E unit 114 converts the optical signal input from the first multiplexing unit 101 into an electric signal and outputs the electric signal to the second client-side E/O unit 124. The second client-side E/O unit 124 converts the input electric signal into an optical signal and outputs the optical signal to the second client port of the first multiplex transmission apparatus 100.

In this way, the first line-side E/O unit 111, the first line-side O/E unit 112, the first client-side O/E unit 121 and the first client-side E/O unit 122 correspond to the first client port of the first multiplex transmission apparatus 100. In addition, the second line-side E/O unit 113, the second line-side O/E unit 114, the second client-side O/E unit 123 and the second client-side E/O unit 124 correspond to the second client port of the first multiplex transmission apparatus 100.

In the present embodiment, the first multiplex transmission apparatus 100 further includes a standby system client port and a standby system transmission/reception unit that corresponds to the standby system client port. The standby system transmission/reception unit is constituted of a standby system line-side E/O unit 115, a standby system line-side O/E unit 116, a standby system client-side O/E unit 125, and a standby system client-side E/O unit 126.

The second multiplex transmission apparatus 200 is configured in the same manner as the first multiplex transmission apparatus 100. Illustration of an internal configuration of the second multiplex transmission apparatus 200 will be omitted. As described above, the second multiplex transmission apparatus 200 is provided with the third client port and the fourth client port. The second multiplex transmission apparatus 200 includes a client-side O/E unit and a client-side E/O unit that correspond to each client port. The second multiplex transmission apparatus 200 includes a line-side O/E unit and a line-side E/O unit that correspond to each client port. In addition, the second multiplex transmission apparatus 200 includes a second multiplexing unit which functions similarly to the first multiplexing unit 101. Furthermore, the second multiplex transmission apparatus 200 includes a standby system client port and a standby system transmission/reception unit which function similarly to the first multiplexing unit 101.

The line-side O/E units and the line-side E/O units included in each multiplex transmission apparatus are made of optical modules that emit light at a fixed wavelength. The line-side O/E units and the line-side E/O units included in the first multiplex transmission apparatus 100 can communicate only with an optical module which emits light at the same wavelength as themselves among the line-side O/E units and the line-side E/O units included in the second multiplex transmission apparatus 200.

Each slave station and the first multiplex transmission apparatus 100 are connected to each other via, for example, a coupler 150 in order to construct a redundant configuration of a transmission line. Accordingly, when a failure occurs in any system of each client port, the standby system client port and the standby system transmission/reception unit can be made to function. Similarly, each master station and the second multiplex transmission apparatus 200 may be connected to each other via a coupler for constructing a redundant configuration of a transmission line. In place of the coupler, a switch provided inside each multiplex transmission apparatus may be used to construct a redundant configuration of the transmission line between the base station and each multiplex transmission apparatus.

In the illustrated configuration example, the first multiplex transmission apparatus 100 includes a first line switching unit 102 for constructing a redundant configuration of a transmission line between multiplex transmission apparatuses. Although not illustrated, the second multiplex transmission apparatus 200 includes a second line switching unit that functions similarly to the first line switching unit 102. The line switching units are for constructing a redundant configuration of a transmission line between the multiplex transmission apparatuses. The line switching units are connected to each other by a plurality of paths (optical fiber cables). In the illustrated configuration example, the line switching units are connected to each other by two paths. A signal from the multiplexing units is input to the line switching units. The line switching units select an arbitrary path among the plurality of paths connecting the line switching units, and output a signal from the multiplexing unit to the selected line. The line switching units may be provided outside the multiplex transmission apparatuses. As described above, in the present embodiment, the first multiplex transmission apparatus 100 and the second multiplex transmission apparatus 200 are connected to each other by a plurality of switchable transmission paths.

In addition, as shown in FIG. 2, in the present embodiment, the first multiplex transmission apparatus 100 includes a resource pool 130. The resource pool 130 is constituted of, for example, a rewritable FPGA. Various electrical functions can be flexibly added to and deleted from the resource pool 130. The resource pool 130 constructs a necessary function by partially or entirely rewriting the resource pool 130 as necessary. During normal time in which no failure occurs, the resource pool 130 constructs a function necessary or effective during normal time. In addition, when a failure occurs, the resource pool 130 constructs a function for realizing a redundant configuration for coping with the failure.

In the present disclosure, a redundant configuration is constructed using the resource pool 130 that commonly functions both during normal time and during an occurrence of a failure. Accordingly, resources can be utilized more effectively than before. According to the present disclosure, it is possible to realize a redundant configuration for coping with a failure while reducing useless resources.

The resource pool 130 may also be provided in the second multiplex transmission apparatus 200. In the present disclosure, the resource pool 130 need only be provided in at least one of the first multiplex transmission apparatus 100 and the second multiplex transmission apparatus 200.

In the present embodiment, the resource pool 130 can construct an electrical processing function for performing signal processing. During normal time, an electrical processing unit is constructed as a functional unit having an electrical processing function in the resource pool 130. Electrical processing functions as used herein include an error correction processing function and a modulating function. The error correction processing function is a function for correcting a bit error rate due to signal deterioration occurring on a transmission path. By constructing the error correction processing function, accurate signal transmission can be performed even when the transmission path is long. In addition, the modulating function is a function for converting a signal from a client port into a multi-valued signal. By constructing the modulating function, a bit rate can be increased while maintaining a baud rate. Constructing the modulating function in advance enables a cost of O/E units and E/O units to be reduced.

In addition, the multiplex transmission system according to the present embodiment includes a management control unit 140 as a control unit for controlling the resource pool 130. The management control unit 140 includes, for example, a resource pool-side monitoring unit 141, a line-side monitoring unit 142, and a resource calculating unit 143. Although the management control unit 140 is provided outside the first multiplex transmission apparatus 100 in the illustrated configuration example, at least a part of the functions of the management control unit 140 may be provided inside the first multiplex transmission apparatus 100. In addition, at least a part of the functions of the management control unit 140 may be provided inside the second multiplex transmission apparatus 200.

The resource pool-side monitoring unit 141 monitors a current state of the resource pool 130. Monitoring information by the resource pool-side monitoring unit 141 is sent to the resource calculating unit 143. The line-side monitoring unit 142 monitors states of the first line-side E/O unit 111, the first line-side O/E unit 112, the second line-side E/O unit 113, and the second line-side O/E unit 114. The monitoring information by the line-side monitoring unit 142 is sent to the resource calculating unit 143. For example, when any one of the first line-side E/O unit 111, the first line-side O/E unit 112, the second line-side E/O unit 113, and the second line-side O/E unit 114 breaks down, the line-side monitoring unit 142 notifies the resource calculating unit 143 of the breakdown. The resource calculating unit 143 performs calculation processing for constructing each functional unit in a resource in the resource pool 130. The resource calculating unit 143 performs calculation processing on the basis of the monitoring information transmitted from the resource pool-side monitoring unit 141 and the line-side monitoring unit 142. In addition, the resource calculating unit 143 instructs the resource pool 130 to construct a necessary functional unit on the basis of the calculation processing result.

The management control unit 140 may be constituted of a computer including a processor and a memory as hardware. The processor is also referred to as a CPU (Central Processing Unit), a central processing device, processing equipment, an arithmetic unit, a microprocessor, a microcomputer, or a DSP. As the memory, for example, non-volatile or volatile semiconductor memories such as a RAM, a ROM, a flash memory, an EPROM, or an EEPROM, a magnetic disk, a flexible disk, an optical disk, a compact disc, a mini disk, a DVD, and the like are applicable.

A program as software is stored in the memory of the management control unit 140. The management control unit 140 performs preset processing by causing a processor to execute a program stored in the memory and implements each function as a result of cooperation between hardware and software.

FIG. 2 shows an operating state during normal time of the multiplex transmission system according to the first embodiment. During normal time, an electrical processing unit associated with a transmission/reception unit corresponding to the first client port and an electrical processing unit associated with a transmission/reception unit corresponding to the second client port are respectively constructed in the resource pool 130.

Next, a flow of operations of the multiplex transmission system configured as described above will be described. As described above, during normal time where no failure occurs, it is assumed that an electrical processing function associated with each of the plurality of client ports is constructed in the resource pool 130. During normal time, the management control unit 140 controls the resource pool 130 so that an electrical processing function associated with each of the transmission/reception units provided in the first multiplex transmission apparatus 100 is constructed. This control step during normal time is also referred to as a normal-time function construction step in the present disclosure.

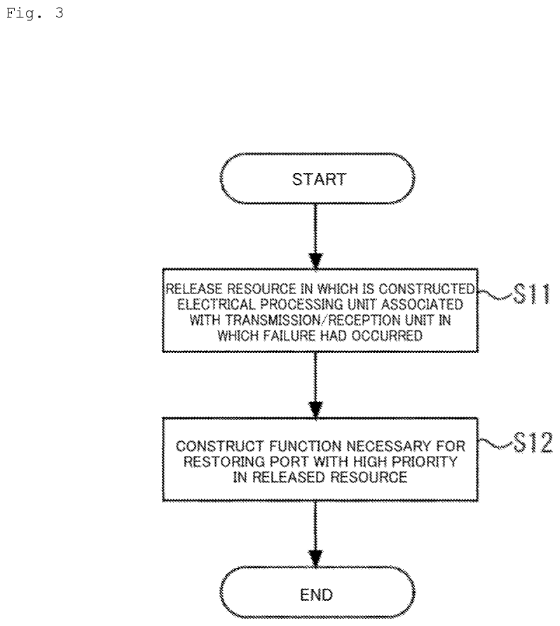

FIG. 3 is a flow chart showing a flow of a resource control method for the multiplex transmission system according to the first embodiment. FIG. 3 describes operations in the event of an occurrence of a failure in a transmission/reception unit. When a failure occurs, first, in step S11, a resource in which is constructed an electrical processing function associated with the transmission/reception unit in which the failure had occurred is released. The processing in step S11 is also referred to as a resource release step in the present disclosure.

In subsequent step S12, an electrical processing function associated with the standby system transmission/reception unit is constructed in the resource released in the resource release step. The processing in step S12 is also referred to as a function reconstruction step in the present disclosure. Due to the function reconstruction step, the standby system client port and the standby system transmission/reception unit can be made to function accurately.

According to the resource control method as shown in FIG. 3 and the multiplex transmission system configured to be capable of executing the resource control method, a redundant configuration capable of accurately restoring communication in the event of an occurrence of a failure can be realized without requiring an excessively large resource.

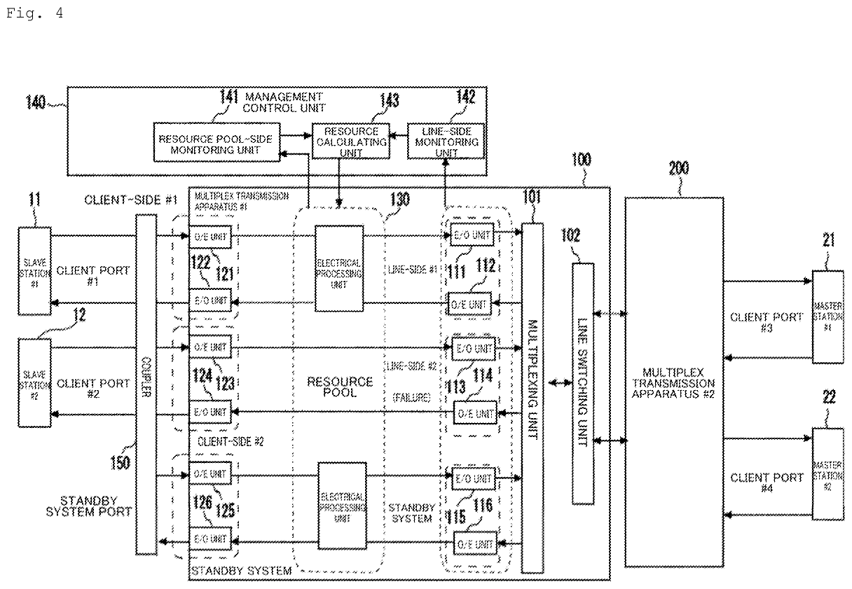

FIG. 4 is a block diagram describing an operation example in the event of an occurrence of a failure in a transmission/reception unit of the multiplex transmission system according to the first embodiment. FIG. 4 shows an operation example in a case where a failure occurs in the second line-side E/O unit 113 or the second line-side O/E unit 114. At this point, it is difficult to perform accurate signal transmission by simply switching a path of the second client port system to the standby client port system by the coupler 150, a switch, or the like. Therefore, a resource in which the electrical processing unit associated with the second line-side E/O unit 113 and the second line-side O/E unit 114 had been constructed is released and an electrical processing unit associated with the standby system transmission/reception unit is constructed in the resource. Accordingly, accurate signal transmission through the transmission path of the standby system can be performed.

In addition, the multiplex transmission apparatus constituting the multiplex transmission system according to the present disclosure and the resource control method for the multiplex transmission system can also be realized through cooperation between hardware and software by having a processor execute a program stored in a memory to perform preset processing. Furthermore, a program for realizing the apparatus and the method according to the present disclosure can be recorded on an information recording medium. Alternatively, a program for realizing the apparatus and the method according to the present disclosure can also be provided via a communication network.

### INDUSTRIAL APPLICABILITY

The present disclosure can be used for a multiplex transmission system which multiplexes and transmits a plurality of signals between a first multiplex transmission apparatus and a second multiplex transmission apparatus and for resource control of the multiplex transmission system.

### REFERENCE SIGNS LIST

11 First slave station
12 Second slave station
21 First master station
22 Second master station
100 First multiplex transmission apparatus
101 First multiplexing unit
102 First line switching unit
111 First line-side E/O unit
112 First line-side O/E unit
113 Second line-side E/O unit
114 Second line-side O/E unit
115 Standby system line-side E/O unit
116 Standby system line-side O/E unit
121 First client-side O/E unit
122 First client-side E/O unit
123 Second client-side O/E unit
124 Second client-side E/O unit
125 Standby system client-side O/E unit
126 Standby system client-side E/O unit
130 Resource pool
140 Management control unit
141 Resource pool-side monitoring unit
142 Line-side monitoring unit
143 Resource calculating unit
150 Coupler
200 Second multiplex transmission apparatus

1. A multiplex transmission system which multiplexes and transmits a plurality of signals between a first multiplex transmission apparatus and a second multiplex transmission apparatus, the multiplex transmission system comprising:
a resource pool which is provided in the first multiplex transmission apparatus and which has a resource that enables a function to be rewritten; and
a control unit which controls the resource pool, wherein
the first multiplex transmission apparatus includes: at least one client port to which a client apparatus can be connected; a transmission/reception unit corresponding to the client port; a standby system client port; and a standby system transmission/reception unit corresponding to the standby system client port,
during normal time, an electrical processing function associated with each of the transmission/reception units is constructed in the resource pool, and
when a failure occurs in the transmission/reception unit, the control unit controls the resource pool so as to release a resource in which is constructed an electrical processing function associated with the transmission/reception unit and to construct an electrical processing function associated with the standby system transmission/reception unit in the resource.

2. A method for controlling, in a multiplex transmission system which multiplexes and transmits a plurality of signals between a first multiplex transmission apparatus and a second multiplex transmission apparatus, a resource pool which is provided in the first multiplex transmission apparatus and which has a resource that enables a function to be rewritten, the resource control method comprising the steps of:
constructing, during normal time, an electrical processing function associated with each of transmission/reception units provided in the first multiplex transmission apparatus;
releasing, when a failure occurs in a transmission/reception unit, a resource in which is constructed an electrical processing function associated with the transmission/reception unit; and
constructing an electrical processing function associated with a standby system transmission/reception unit provided in the first multiplex transmission apparatus in the resource released in the step of releasing a resource.
